(19) United States
(12) Patent Application Publication
(10) Pub. No.: US 2021/0365989 A1
(43) Pub. Date: Nov. 25, 2021

(54) A MOBILE PROJECTION SYSTEM FOR DISPLAYING TARGETED ADVERTISEMENTS ON WINDOWS OF A VEHICLE

(71) Applicant: GAURAV GARG, MILPITAS, CA (US)

(72) Inventor: GAURAV GARG, MILPITAS, CA (US)

(21) Appl. No.: 16/965,120

(22) PCT Filed: Dec. 1, 2018
(86) PCT No.: PCT/IN18/50805

§ 371 Date: Jul. 27, 2020

(30) Foreign Application Priority Data
Dec. 1, 2017 (IN) 201741043123

(51) Int. Cl. G06Q 30/02; G09F 21/04; G09F 19/18; H04W 4/23; H04W 4/40

(52) U.S. Cl. CPC G06Q 30/0266; G09F 21/049; H04W 4/40; H04W 4/23; G09F 19/18

(57) ABSTRACT

Disclosed herein is a mobile projection system (100) which is attachable and detachable to a portion of a moving or static vehicle for displaying targeted advertisements and images on windows of the vehicle. The system (100) includes a personal cellular telecommunication device (101) with an advertisement content transferring module (103). A server (105) is connected with the telecommunication device (101) via internet as shown in FIG. 3. The system further includes a projecting device (107) having a base unit (109) and a microprocessor (111) integrated within it. The location determination module (113) with GPS receiver (115) determines the location of a vehicle and transmits it to the server. The selected advertisement content based on arbitration process is transmitted to the telecommunication device. The received content is transferred to the projecting device (107) via wired/wireless technology. The advertisement content is then casted on the windows of the vehicle.

### FIELD OF THE INVENTION

The present invention relates generally to mobile advertising systems and more particularly relates to a mobile projection system which is attachable and detachable to a portion of a vehicle for real-time display of dynamic contents such as targeted advertising in static or moving vehicles.

### BACKGROUND

Generally, outdoor advertising is done at fixed locations such as billboards, digital signage billboards or on buildings. The content in the fixed locations is periodically changed based on the preference of the advertiser or the preference of the person leasing the advertising space. Thus, the effectiveness of the content depends largely on the number of people who see it, as well as the relevance of the content to the people who see it.

Nowadays, advertisements are also commonly placed on moving vehicles such as buses, taxicabs, transit vehicles and the like to allow more people to see an advertisement. Trucks with the sole purpose of serving as mobile billboards are becoming more common. By making the advertisement mobile, not only more people can see it, but also it can be delivered to areas that might otherwise be unreachable because of advertising restrictions or prohibitive costs.

Many system and methods are known in the existing art that uses an LCD or similar kind of display in front of the window, license plate or rear of a car to display the advertisement. PCT application WO2013003797 to Michael Conrad JORDAN et al. entitled “System and methods for rendering content on a vehicle” uses an LCD or something similar kind of display in front window; license plate or rear of car, wired or wirelessly connected mobile electronic device with the display device.

United States Patent Application No. 20140040016 to Vanya Amla et al., entitled “Real-time targeted dynamic advertising in moving vehicles” relates to a removably mounted display panel on window of the vehicle, where the Ads/images displayed on windows/display systems attached on windows of moving/static vehicle. Here, camera collects the traffic conditions and others and send it to remote site.

United States Patent Application No. 20160098756 to Peter Ayre, entitled “Device and system for displaying advertising” deals with the display panel mounted on a vehicle to display the advertisement on the vehicle, where the ad is selected by the vehicle owner based on the content and approved through web portal.

Patent and Publication numbers US20150220991, WO2016082020 and US20130246181 relate to a vehicle mounted with a display device to display the advertisement on the display where the displayed advertisement is based on the location of a vehicle, desired advertisement information or selected by the serving engine.

Patent and Publication numbers WO2016162860, DE112015003882, CN106507074 and US20100259058 relate to a vehicle with the projection unit to display the advertisement. These advertisement contents may in the form of text/image/videos that are displayed through vehicle windshields or visual content displayed on window or advertisement displayed on displays.

A limitation associated with the existing prior art implementations is that a billboard or advertisement affixed to a vehicle cannot be changed while the vehicle is moving. Therefore, the content provided cannot be changed frequently and remains static. Also, the content may not be relevant to the people viewing it, hence the effectiveness of the advertisement is reduced.

To overcome the above drawback, dynamic advertising method using changeable displays is used. In this case, the content displayed is selected from a number of available advertisements pre-loaded onto the mobile advertising vehicle.

Even with the use of dynamic advertising, the prior art remains problematic because the advertisements are generally changed according to a fixed schedule without regard to the present audience. Accordingly, the content being displayed may not be relevant to the people who are viewing it and as a result the effectiveness of the advertisement is reduced.

Therefore, there is a need for a mobile projection system that can more effectively deliver target advertisements and other content provided by mobile advertisers.

### SUMMARY

The primary objective of the present invention is to provide a mobile projection system to effectively deliver the target advertisements provided by mobile advertisers.

Another objective of the present invention is to provide a mobile projection system which is attachable and detachable to a portion of a moving or static vehicle for displaying targeted advertisements and images on windows of the vehicle.

To achieve the above objectives, the present invention discloses a mobile projection system which comprises a personal cellular telecommunication device (preferably, a computer with LTE module) with an advertisement content transferring module, a server connected with the personal cellular telecommunication device via internet, a projecting device having a base unit, a microprocessor integrated within the base unit, a location determination module which includes a GPS receiver to access the vehicle location and send the vehicle location to the server, a projection means for displaying advertisements and a rear projection film on the vehicle window.

According to the present invention, the method for displaying targeted advertisements and images on windows of a moving or static vehicle, comprising: determining location of the vehicle and transmitting it to a server; selecting the advertisement content to be displayed based on arbitration process; transmitting the selected content to an advertisement content transferring module in the personal cellular telecommunication device of a person inside the vehicle; transferring the received content to the projecting device via wired/wireless technology and casting the advertisement content on the windows of the moving or static vehicle.

According to an embodiment, a rear projection system is used for advertising the content to audience outside of the vehicle and a front projection system to display content for people sitting inside the vehicle.

In another embodiment, the projection unit casts the advertisement in single/multiple windows. Based on the screen size and number of screens used for displaying the advertisement, the owner of the vehicle is offered with a payment/money.

These objectives and advantages of the invention will become more evident from the following detailed description when taken in conjunction with the accompanying drawings.

### BRIEF DESCRIPTION OF THE DRAWINGS

FIG. 1 illustrates the block diagram of the mobile projection system;

FIG. 2 shows the mobile projection system with projecting means casting advertisements on one side of the vehicle window;

FIG. 3 shows the mobile projection system with projecting means casting advertisements on both sides of the vehicle window;

FIG. 4 depicts (a) Front projection and (b) Rear Projection;

FIG. 5 shows rear projection system and advertisement displayed on vehicle;

FIG. 6 illustrates an exemplary embodiment of a projector placed in a rear-seating area of a vehicle;

FIG. 7 illustrates a method for displaying targeted advertisements on a vehicle; and

FIG. 8 shows the image dimension/ad banner dimension details of the mobile projection system.

### DETAILED DESCRIPTION OF THE INVENTION

The present invention provides a system and method to display the targeted advertisements and images on windows of a moving or a static vehicle.

According to the present invention, the mobile projection system is attachable and detachable to a portion of a moving or a static vehicle.

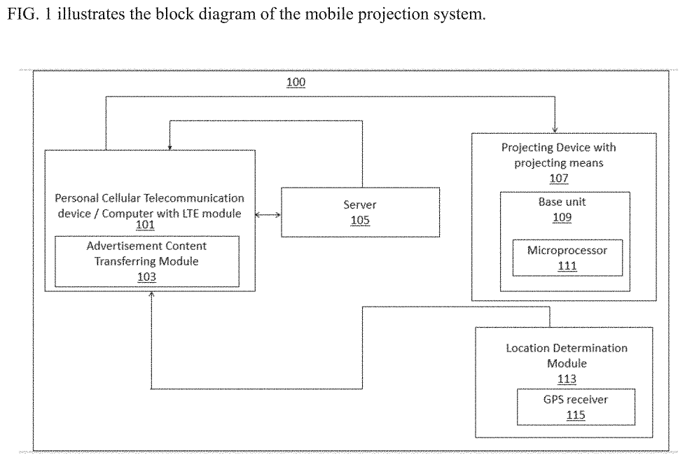

Referring to FIG. 1, the system (100) for displaying the targeted advertisements and images on windows of a vehicle, comprises a personal cellular telecommunication device (101) with an advertisement content transferring module (103), a server (105) connected with the personal cellular telecommunication device (101) via internet, a projecting device (107) having a base unit (109), a microprocessor (111) integrated within the base unit (109), a location determination module (113) includes a GPS receiver (115) to get the vehicle location and send the vehicle location to the server (105), a projection means (107) for displaying advertisements and a rear projection film on the vehicle window.

With reference to the present invention, the personal cellular telecommunication device (101) described herein preferably includes a computer with LTE module but is not limited to a smartphone, mobile phone, tablet and the like. The projection in the car window is flexible i.e., it takes the car's windows shape and curve. Also, car windows have thin film pasted with adhesive which acts as medium for displaying the content.

The location determination module (113) of the system (100) determines the location of the vehicle and transmits it to the server (105). The server (105) which holds the advertisement content selects the relevant content to be displayed on the window of the vehicle based on arbitration process which depends on multiple factors such as bid offered, distance of business from GPS location, surrounding businesses. The selected advertisement content is transmitted to the personal cellular telecommunication device (101) of the person inside the vehicle via internet. The advertisement content transferring module (103) in the personal cellular telecommunication device (101) transfers the received advertisement content to the projecting device (107) via HDMI or any wired technology or Wifi/Bluetooth/DLNA or any other wireless technology. The projection means casts the relevant advertisement content on windows of the moving or static vehicle.

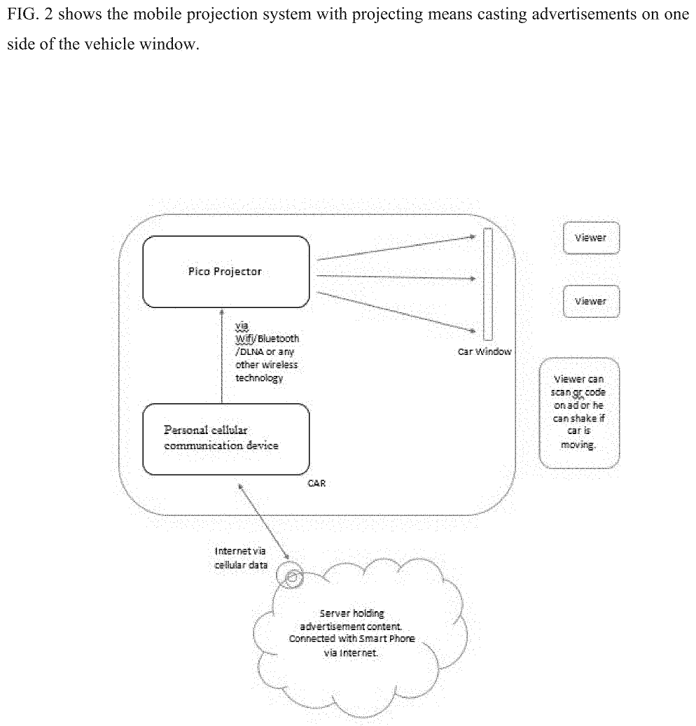

Referring to FIG. 2, a car is connected to a server holding advertisement content via internet. The car consists of a personal cellular telecommunication device having an advertisement content transferring module and is connected to a projecting device via HDMI or any other wired technology or Wifi/Bluetooth/DLNA or any other wireless technology.

Based on the geolocation of the vehicle, an advertisement related to that particular location is selected and is transmitted from server to a personal cellular telecommunication device, the advertisement content transferring module in personal cellular telecommunication device transfers it to the projecting device via Wifi/Bluetooth/DLNA or any other wireless technology. The projecting device casts the advertisement content onto one side of the car window.

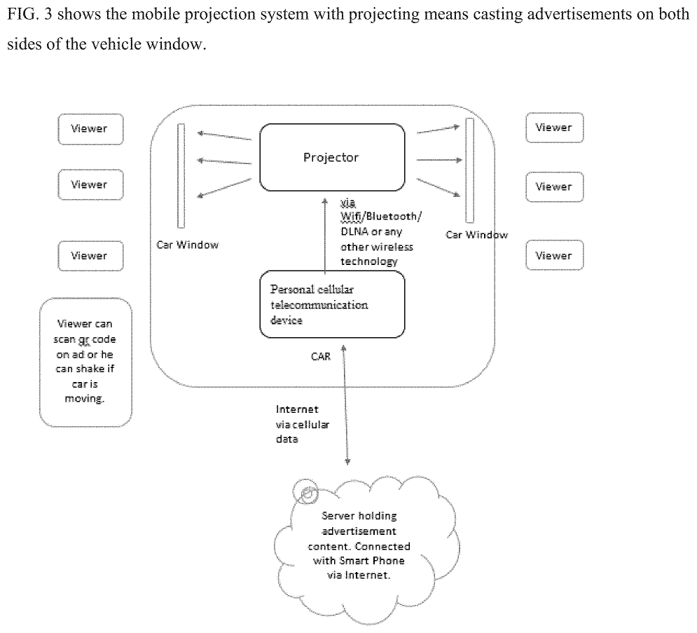

FIG. 3 represents the advertisement displayed on both sides of the vehicle window. Referring to FIG. 3, a car is connected to a server holding advertisement content via internet. The car consists of a personal cellular telecommunication device having an advertisement content transferring module and it is connected to a projecting device via Wifi/Bluetooth/DLNA or any other wireless technology.

Based on the geolocation of the vehicle, an advertisement related to that particular location is selected and is transmitted from server to a personal cellular telecommunication device, the advertisement content transferring module in personal cellular telecommunication device transfers it to the projecting device via Wifi/Bluetooth/DLNA or any other wireless technology. The projecting device casts the advertisement content onto both sides of the car window.

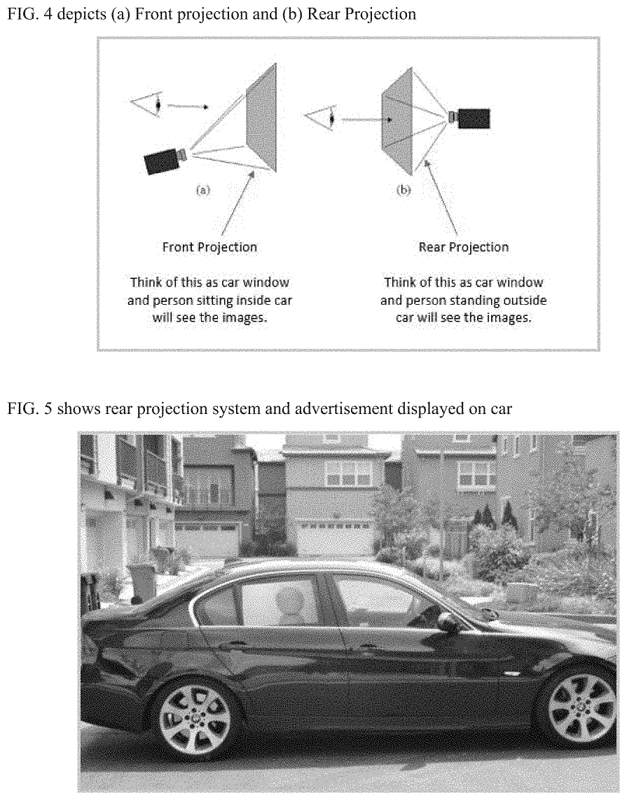

Referring to FIG. 4, a rear projection system is used for advertising the content to audience who are present outside of the vehicle. The persons standing outside of the car can see the images in the car window. A front projection system is used to display content for people sitting inside the car.

Referring to FIG. 5, an advertisement is displayed on car window with the rear projection system so that person standing outside the car can see the images in the car window.

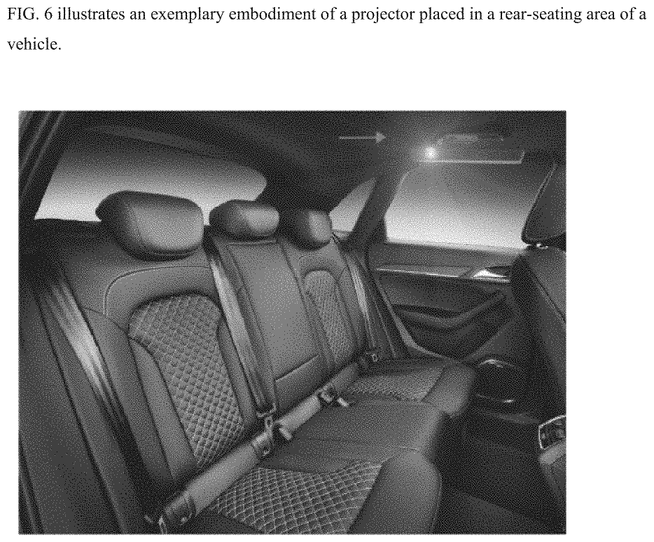

According to an exemplary embodiment, the projector is placed in a rear-seating area of a vehicle as depicted in FIG. 6.

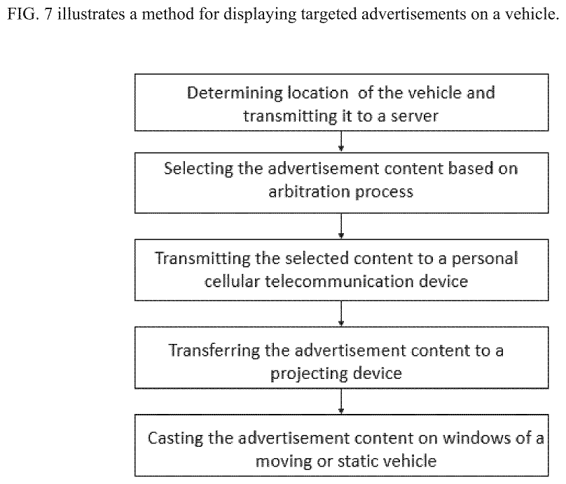

According to the present invention, the method for displaying targeted advertisements and images on windows of a moving or static vehicle as illustrated in FIG. 7, comprises: determining location of the vehicle and transmitting it to a server; selecting the advertisement content to be displayed based on arbitration process; transmitting the selected content to an advertisement content transferring module in the personal cellular telecommunication device of a person inside the vehicle; transferring the received content to the projecting device via wireless technology and casting the advertisement content on the windows of the moving or static vehicle.

According to an embodiment, the rear projection system is used to advertise the content to audience who are present outside of the vehicle and a front projection system to display the content for people sitting inside the vehicle.

In another embodiment, the projection unit casts the advertisement in single/multiple windows. Based on the screen size and number of screens used for displaying the advertisement, the owner of the vehicle is offered with a payment/money. Here, the driver paid is based on area he has driven.

In one aspect, the specifications/features of the projection system used in the present invention preferably comprises projector luminosity in the range 2500-3500 ANSI Lumens, where the luminosity range increases/decreases according to day and night time, power consumption in the range of 150 W-175 W. In the projection system, image content is video and digital banners and the rear side mirrors are installed with blind spot mirrors. Images/videos displayed in the projector is HD with 1080P resolution.

In another aspect, the mounting of the projector system is given. Hardware device of the projector is installed after removing car grab handle from ceiling.

Furthermore, the rear projector films use preferably three types of films namely diffusion film, PDLC film and Nano ARVR. All the three films have clear adhesive which enables screens to pasted on car windows.

The physical specifications of the diffusion film preferably comprise a thickness of 140 microns, vision angle of 130° (with 20% brightness loss), 68% of transmittance, 87% of haze, peak of +/−3%, gain of 4, usage temperature in the range of 0°-60°, usage humidity in the range of 0%-80%

Additionally, the characteristics of PDLC film includes: (a) film turns clear on application of AC voltage. Voltage range depends on size of car window; (b) When no voltage is applied; film turns in diffusion film; and (c) Voltage is provided by a hardware inverter.

The Nano ARVR film provides a transparent screen which is installed on car windows. This film blocks the projector light coming from car inside.

The exemplary specification of the targeted advertisement as disclosed in the method of the present invention is given in the below table based on the IAB standards.

| | | | | | Size Range Maximum | | | | | |
|---|---|---|---|---|---|---|---|---|---|---|
| | | | | | Minimum | Maximum | | | | |
| | | Transition | | | Size | Size | | | | |
| | | Fixed Size | Aspect | | Width × | Width × | | | | |
| | Ad unit | Ad unit | Ratio | Ad | height | height | K-Weight (MB) | | | Static/Video |
| Ad Type | Name | (px)* | (width:height) | Size** | (dp***) | (dp***) | Maximum size | | | Size (dp) |
| Full Page | 16 × 10 | N/A | 16:10 | X | | 1920 × 1080 | Static | Video | GIF | 1920 × 1080 |
| Landscape | | | | Large | | | Image | 50 MB | 20 MB | |
| | | | | | | | 10 MB | Max | Max | |
| | | | | | | | | 30 sec | 10 sec | |

Few sample text guidelines for video and static banners of the advertisements includes:
1. Fewer words conveying message both in Video and Static Banner, such as displaying:
   a. Product LOGO
   b. Key Product offering
   c. Call for action
2. Using bigger Font for key words, so that visible from distance
3. Using background white with contrasting color for text. Preferably, RED with white background.
4. Keeping Product name visible throughout the video for brand/name recall
5. Keeping the content tittle/background safe
6. For 4-5 sec frame of the Video, one message is read

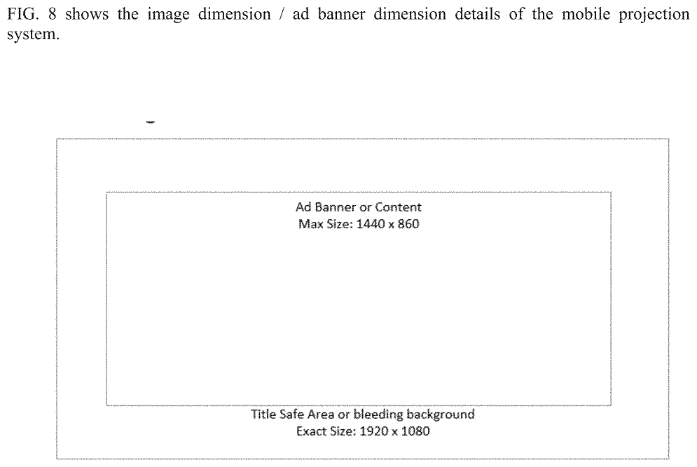

Advantageously, the dimension of ad banner/content and title safe area/bleeding background is designed such that these dimensions can display image in any car with different window shapes and still not losing information content from advertisement. The maximum size/dimension of ad banner or content is 1440×860 and the exact size of title safe area is 1920×1080 as shown in FIG. 8.

The present invention is used in targeting advertisements to attract audience. This can be used by local shops where the local shops can advertise daily deals on all cars within some fixed radius.

Big businesses can run immediate campaigns all over the places. Ride share cars or individual cars will make money while driving.

The present invention can also be applied to future use with the proposal of new hardware inside the car to learn external environment patterns which then can be used as input for other data analysis. For example, self-driving techniques can use maps, situation recording while driving.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A mobile projection system (100) for displaying targeted advertisements and images on windows of a moving or static vehicle, comprising:
a. a personal cellular telecommunication device (101) with advertisement content transferring module (103);
b. a server (105) connected with the personal cellular telecommunication device (101) via internet; and
c. a projecting device (107) comprising (i) a base unit (109); (ii) a microprocessor (111) integrated within the base unit (109); (iii) a location determination module (113) to send vehicle location to the server (105); and (iv) a projection means (107) for displaying advertisements;

2. The mobile projection system (100) as claimed in claim 1, wherein the vehicle window comprises a rear projection film.

3. The mobile projection system (100) as claimed in claim 1, further comprises a rear projection system to display content for people outside the vehicle.

4. The mobile projection system (100) as claimed in claim 1, further comprises a front projection system to display content for people sitting inside the vehicle.

5. The mobile projection (100) system as claimed in claim 1, wherein the projection means (107) casts the advertisement in single or multiple windows.

6. The mobile projection (100) system as claimed in claim 1, wherein the personal cellular telecommunication device (101) is a computer with LTE module.

7. The mobile projection (100) system as claimed in claim 1, wherein the personal cellular telecommunication device (101) is a smartphone, tablet or a PDA.

8. A method for displaying targeted advertisements and images on windows of a moving or static vehicle, comprising:
a. determining location of the vehicle and transmitting it to a server;
b. selecting the advertisement content to be displayed based on arbitration process;
c. transmitting the selected content to an advertisement content transferring module in the personal cellular telecommunication device of a person inside the vehicle;
d. transferring the received content to the projecting device through a wired or wireless technology; and
e. casting the advertisement content on the windows of the moving or static vehicle.
